(19) United States
(12) Patent Application Publication
(10) Pub. No.: US 2013/0288705 A1
(43) Pub. Date: Oct. 31, 2013

(54) WIRELESS LOCATION DETERMINATION APPARATUS AND METHOD USING WEIGHTED VALUE IN WIRELESS COMMUNICATION NETWORK

(71) Applicant: Electronics and Telecommunications Research Institute, (US)

(72) Inventors: Jee Hwan AHN, Daejeon (KR); Kanghee KIM, Daejeon (KR); Geon Min YEO, Daejeon (KR)

(73) Assignee: Electronics and Telecommunications Research Institute, Daejeon (KR)

(21) Appl. No.: 13/870,659

(22) Filed: Apr. 25, 2013

(30) Foreign Application Priority Data
Apr. 25, 2012 (KR) 10-2012-0043307

(51) Int. Cl. H04W 64/00

(52) U.S. Cl. CPC H04W 64/00
USPC 455/456.1

(57) ABSTRACT

Disclosed is a wireless location determination apparatus using weighted values in a wireless communication network, including: a fixed infrastructure searching unit configured to search and accept information of nodes to be located and neighbor fixed infrastructures; an infrastructure combination generating unit configured to generate fixed infrastructure combinations to be used for location determination from the information of the fixed infrastructures; a location determination information element extracting unit configured to extract location determination information elements between the fixed infrastructures from each generated fixed infrastructure combination; a weighted value calculating unit configured to allocate the weighted values to each fixed infrastructure combination using the extracted location determination information elements; a fixed infrastructure combination selecting unit configured to select the fixed infrastructure combinations for location determination using the allocated weighted values; and a location calculating unit configured to calculate locations of the nodes to be located using the selected fixed infrastructure combinations.

### CROSS-REFERENCES TO RELATED APPLICATIONS

The present application claims priority under 35 U.S.C 119(a) to Korean Application No. 10-2012-0043307, filed on Apr. 25, 2012, in the Korean Intellectual Property Office, which is incorporated herein by reference in its entirety set forth in full.

### BACKGROUND

Exemplary embodiments of the present invention relate to a wireless location determination apparatus and method using weighted values in a wireless communication network, and more particularly, to a wireless location determination apparatus and method using weighted values in a wireless communication network capable of more precisely selecting a plurality of fixed infrastructures to be used for location determination, by allocating the weighted values to available location determination elements from the fixed infrastructures and using the weighted values.

Wireless location determination means determining a location, a speed, and other characteristics of an object using propagation characteristics of a radio wave or acquiring information related to these data. A wireless location determination technology has been widely used as a technology of measuring a location of a terminal in a satellite navigation system such as a global positioning system (GPS) or a wireless communication system such as code division multiple access (CDMA), wireless local area network (WLAN), ultra wideband (UWB), Bluetooth, and the like, and applications thereof have been recently expanded with an increase in a demand for location information.

Generally, the wireless location determination selects at least three fixed nodes (infrastructures) to be used for location determination. In other words, neighbor fixed infrastructures distributed around a serving fixed infrastructure of nodes to be located are present. In this case, the location determination of nodes to be located is performed by calculating distances or angles among each fixed infrastructure and the nodes to be located based on the already known location information of the plurality of fixed infrastructures.

In this case, in order to estimate a two-dimensional coordinate of the nodes to be located, a minimum of three fixed infrastructures are required and in order to estimate a three-dimensional coordinate, a minimum of four fixed infrastructures are required. Further, in order to improve the location determination precision, the fixed infrastructures larger than ones described above may be used and the overall acceptable fixed infrastructure information may also be used.

In performing the general location determination, in order to select the fixed infrastructures to be used for location determination, the nodes to be located are first accept signals from the peripheral fixed infrastructures and then, the fixed infrastructures to be used for location determination are selected.

As the methods for selecting fixed infrastructures, there are a method for using location determination of all the receivable fixed infrastructures and a method for selecting only required minimum fixed infrastructures. Among those, the most common method is a method for selecting fixed infrastructures in the order of the large strength of received signals and using the selected fixed infrastructures for location determination.

However, since a cellular mobile communication system adopts a multi-path channel in consideration characteristics of a wireless channel, location determination performance is not improved in proportion to the increase in the strength of the received signal due to non-line-of-sight (NLOS) environment and a fading effect. The reason is that the methods used for location determination are designed based on line of sight (LOS) environment of the received radio wave. Accordingly, no LOS component is or the received strength of the NLOS component may be higher than the LOS component due to the fading effect. This indicates a problem when the fixed infrastructures are selected using the received strength of a radio wave as described above.

As a result, when errors occur even in one of the fixed infrastructures selected in accordance with the methods of the related art due to the effect of the wireless channel at the time of estimating distances and angles among the nodes to be located and the fixed infrastructures, errors also occur even at the time of location determination.

In order to solve the above problems, a method for using the information of all the fixed infrastructures may be used so as to maximally use the LOS component of the received radio wave. The methods each are designed to perform location determination by dividing all the acceptable fixed infrastructures into a combination form of several cases, discriminate a magnitude of error at the time of estimating the distances and the angles among the fixed infrastructures and the nodes to be located by allocating weighted values according to the results to be located, and avoid the fixed infrastructures including the NLOS component as maximally as possible. However, the methods have problem in that the system is complicated and the time required to perform the location determination is also long.

A background art of the present invention is disclosed in Korean Patent No. 10-0645355 (Nov. 6, 2006).

The above-mentioned technical configuration is a background art for helping understanding of the present invention and does not mean related arts well known in a technical field to which the present invention pertains.

### SUMMARY

An embodiment of the present invention is directed to a wireless location determination apparatus and method capable of minimizing or suppressing location determination errors or a reduction in location determination performance occurring due to a use of a multi-path channel in consideration of characteristics of a wireless channel, simplifying a system, and preventing time required for location determination from increasing.

An embodiment of the present invention relates to a wireless location determination apparatus using weighted values in a wireless communication network, including: a fixed infrastructure searching unit configured to search and accept information of fixed infrastructures adjacent to nodes to be located; an infrastructure combination generating unit configured to generate fixed infrastructure combinations to be used for location determination from the information of the fixed infrastructures; a location determination information element extracting unit configured to extract location determination information elements between the fixed infrastructures from each generated fixed infrastructure combination; a weighted value calculating unit configured to allocate the weighted values to each fixed infrastructure combination using the extracted location determination information elements; a fixed infrastructure combination selecting unit configured to select the fixed infrastructure combinations for location determination using the allocated weighted values; and a location calculating unit configured to calculate locations of the nodes to be located using the selected fixed infrastructure combinations.

The location determination information element may include at least any one angle and distance between the fixed infrastructures and strength of received signals from the fixed infrastructures.

The weighted value calculating unit may calculate final weighted values of the infrastructure combinations by applying all the location determination information elements to one function equation or calculate the final weighed values of the infrastructure combinations by separately calculating the weighed values for each type of the location determination information elements and then, adding or multiplying the calculated weighted values.

The fixed infrastructure combination selecting unit may select the infrastructure combinations in an order of the large weighted value.

The fixed infrastructure combination selecting unit may select the infrastructure combinations by avoiding the infrastructure combinations in an order of the small weighted value.

Another embodiment of the present invention relates to a wireless location determination method in a wireless communication network, including: accepting information of fixed infrastructures adjacent to nodes to be located; generating fixed infrastructure combinations to be used for location determination from the information of the fixed infrastructures; extracting location determination information elements between the fixed infrastructures from each generated fixed infrastructure combination; allocating the weighted values to each fixed infrastructure combination using the extracted location determination information elements; selecting the fixed infrastructure combinations for location determination using the allocated weighted values; and performing location calculation using the selected fixed infrastructure combinations.

The information of the fixed infrastructures may be processed by being accepted in the nodes to be located.

The fixed infrastructure combinations may be generated by the nodes to be located.

The nodes to be located may select the fixed infrastructure combinations for location determination and the locations are calculated using the selected fixed infrastructure combinations.

The fixed infrastructure information may be transferred to a transmitting side from the nodes to be located and the transmitting side may generate the fixed infrastructure combinations.

The transmitting side may select the fixed infrastructure combinations for location determination and calculate the locations using the selected fixed infrastructure combinations.

The weighted value allocated to each fixed infrastructure may be calculated by applying all the location determination information elements to a single function equation or may be calculated by a method of obtaining the final weighed values of the infrastructure combinations by separately calculating the weighed values for each type of the location determination information elements and then, adding or multiplying the calculated weighted values.

The selecting of the fixed infrastructure combination for location determination may be performed by a method of selecting the infrastructure combinations in an order of the large weighted value.

The selecting of the fixed infrastructure combination for location determination may be performed by a method of selecting the infrastructure combinations by avoiding the infrastructure combinations in an order of the small weighted value.

### BRIEF DESCRIPTION OF THE DRAWINGS

The above and other aspects, features and other advantages will be more clearly understood from the following detailed description taken in conjunction with the accompanying drawings, in which:

FIG. 1 is a configuration diagram of a wireless location determination apparatus in accordance with an embodiment of the present invention;

FIG. 2 is an exemplified diagram illustrating a distribution of fixed infrastructures of a cellular mobile communication system for describing a wireless location determination method in accordance with an embodiment of the present invention;

FIG. 3 is an exemplified diagram for describing information elements of fixed infrastructure combinations in a wireless location determination method in accordance with the embodiment of the present invention;

FIG. 4 is an exemplified diagram for describing a wireless location determination method based on distance estimation in accordance with the embodiment of the present invention;

FIG. 5 is a flow chart illustrating a process of allowing nodes to be located to calculate a location determination combination in downlink location determination in accordance with an embodiment of the present invention; and

FIG. 6 is a flow chart illustrating a process of allowing a network to perform a calculation of a location determination combination in the downlink location determination in accordance with the embodiment of the present invention.

### DESCRIPTION OF SPECIFIC EMBODIMENTS

Hereinafter, a wireless location determination apparatus and method using weighed values in a wireless communication network in accordance with an embodiment of the present invention will be described with reference to the accompanying drawings. During the process, a thickness of lines, a size of components, or the like, illustrated in the drawings may be exaggeratedly illustrated for clearness and convenience of explanation. Further, the following terminologies are defined in consideration of the functions in the present invention and may be construed in different ways by intention or practice of users and operators. Therefore, the definitions of terms used in the present description should be construed based on the contents throughout the specification.

The present invention selects fixed infrastructures to be used for location determination by allocating weighted values to available location determination elements from the fixed infrastructures and using the allocated weighted values and uses the selected fixed infrastructure for wireless location determination, thereby improving location determination precision of a wireless location determination method in accordance with the related art.

The wireless location determination may be largely classified into two portions according to locations to be measured.

First, among nodes to be located and transmitting infrastructure nodes, one (for example: transmitting infrastructure nodes) generally represents already known and fixed locations and the other one (for example: nodes to be located) represents targets to be located.

When a case in which the location determination is performed in the nodes to be located is referred to as downlink location determination and a case in which the location determination is performed in the transmitting infrastructure nodes is referred to as uplink location determination, the present invention can be applied to both of the uplink and the downlink. For example, in the case of the downlink location determination, the nodes to be located acquire propagation delay information, delay diffusion information, and the like, to directly performing location calculation or handover information to the transmitting side network to perform the calculation. Further, in the case of the uplink location determination, the fixed nodes of which the locations are already known acquire the propagation delay information and the delay diffusion information based on a signal of the nodes to be located to allowing a receiving side network to directly perform the location calculation or handover the information to the transmitting side nodes to be located to perform the calculation.

In this case, the downlink location determination and the uplink location determination are substantially similar to each other in terms of the channel information acquisition or the location calculation. Therefore, for convenience of explanation in the present invention, the downlink location determination will be mainly described, but the scope of the present invention is not limited to the downlink location determination but includes both of the downlink location determination and the uplink location determination.

Hereinafter, for describing the downlink location determination, as an embodiment of the present invention, a cellular mobile communication system among the fixed infrastructure based systems will be considered.

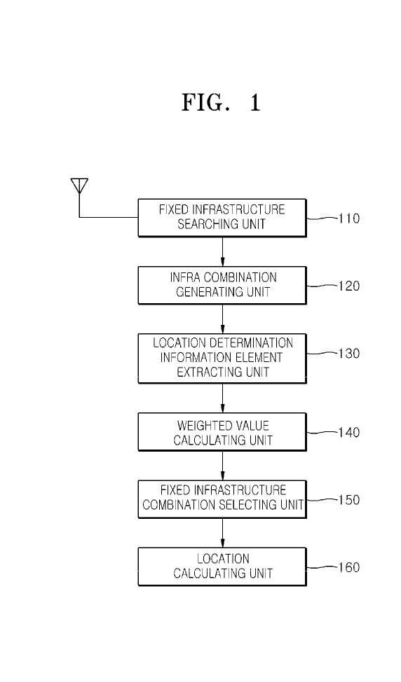

FIG. 1 is a configuration diagram of a wireless location determination apparatus in accordance with an embodiment of the present invention.

As illustrated in FIG. 1, a wireless location determination apparatus in accordance with an embodiment of the present invention is configured to include: a fixed infrastructure searching unit 110 configured to search and accept information of nodes to be located and neighbor fixed infrastructures; an infrastructure combination generating unit 120 configured to generate fixed infrastructure combinations to be used for location determination from the information of the fixed infrastructures; a location determination information element extracting unit 130 configured to extract location determination information elements between the fixed infrastructures from each generated fixed infrastructure combination; a weighted value calculating unit 140 configured to allocate the weighted values to each fixed infrastructure combination using the extracted location determination information elements; a fixed infrastructure combination selecting unit 150 configured to select the fixed infrastructure combinations for location determination using the allocated weighted values; and a location calculating unit 160 configured to calculate locations of the nodes to be located using the selected fixed infrastructure combinations.

The system as described above may be configured in the nodes to be located or the transmitting side network (or fixed infrastructures).

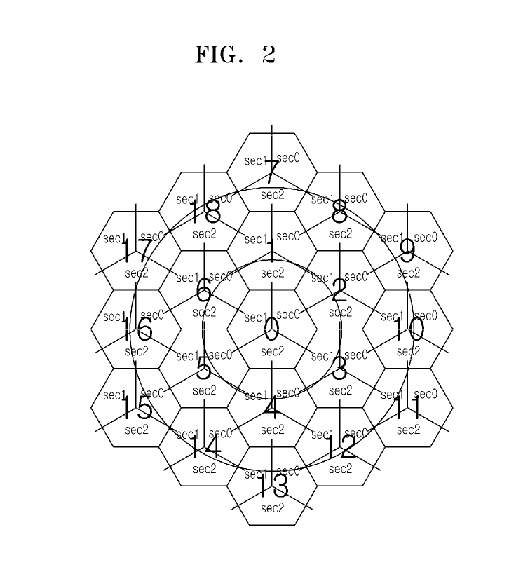

FIG. 2 is an exemplified diagram illustrating a distribution of fixed infrastructures of a cellular mobile communication system for describing a wireless location determination method in accordance with an embodiment of the present invention.

As illustrated in FIG. 2, a general cellular mobile communication system is implemented by a cell configuration in a 2-tier form and a sectorization method. FIG. 2 is illustrated for convenience of explanation related to the embodiment of the present invention, which may be different from a cell configuration of an actual cellular mobile communication system.

Referring to FIG. 2, 18 neighbor fixed infrastructures distributed around a serving fixed infrastructure 0.

As described above, even though the serving fixed infrastructure is included in the wireless location determination, at least two fixed infrastructures need to be selected from 18 neighbor fixed infrastructures so as to estimate a two-dimensional coordinate of the nodes to be located.

Therefore, when the number of fixed infrastructures selected from N fixed infrastructures acceptable in the nodes to be located is set to be k, the number K of cases of the selectable fixed base station combinations may be represented by the following Equation 1 and thus, the selectable base station combinations are represented by the following Equation 2 that is a matrix form. Here, each combination is represented by a single matrix.

$$\begin{matrix}K = ( \begin{matrix}N \\ k\end{matrix} ) = \frac{N !}{k ! ( N - k ) !} & [ Equation 1 ] \\ [ \begin{matrix}{w}_{1} \\ {w}_{2} \\ ⋮ \\ {w}_{K}\end{matrix} ] = [ \begin{matrix}{BS}_{1 , 1} & {BS}_{1 , 2} & … & {BS}_{1 , k} \\ {BS}_{2 , 1} & {BS}_{2 , 2} & … & {BS}_{2 , k} \\ ⋮ & ⋮ & ⋱ & ⋮ \\ {BS}_{K , 1} & {BS}_{K , 2} & … & {BS}_{K , k}\end{matrix} ] & [ Equation 2 ]\end{matrix}$$

As a method for selecting one of the base station combinations, a selecting method using strength of a received signal from the fixed infrastructures in accordance with the related art has been mainly used. However, the present invention uses the overall information to be used for location determination to perform selecting, thereby creating better combinations of performance.

Generally, the location determination in the cellular mobile communication network uses triangulation, trilateration, or multilateration. These measurement methods may be described from a triangle connecting the selected fixed infrastructures and the present invention uses the location determination information extracted from the triangle and shows, by way of example, the case of using only three fixed infrastructures for description. However, the scope of the present invention is not limited to the case in which the selected three base stations (fixed infrastructures) are used. Therefore, at least four base stations (fixed infrastructures) may be used for location determination.

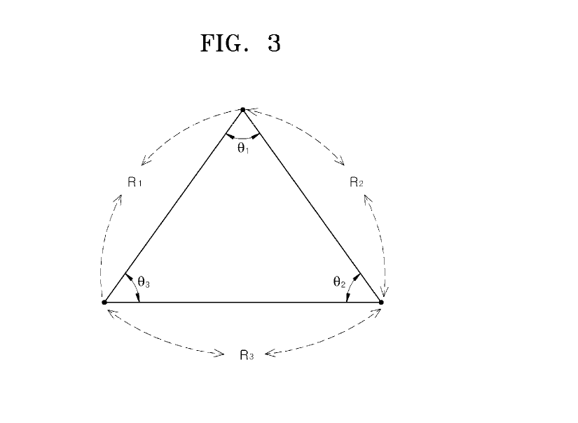

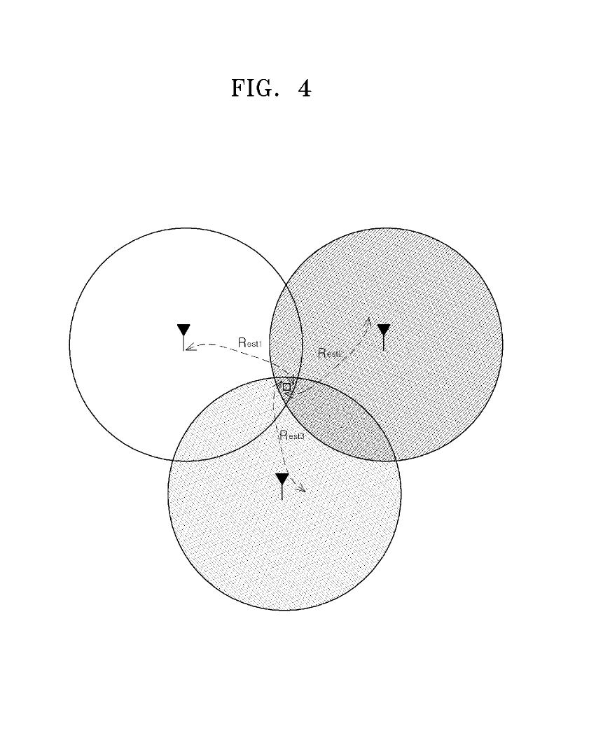

FIG. 3 is an exemplified diagram for describing information elements of fixed infrastructure combinations in a wireless location determination method in accordance with the embodiment of the present invention and FIG. 4 is an exemplified diagram for describing a wireless location determination method based on distance estimation in accordance with the embodiment of the present invention.

As illustrated in FIG. 3, distance values and angles among the fixed infrastructures may be extracted from the triangle connecting the selected three fixed infrastructures. In other words, since a coordinate (location information) of each fixed infrastructure is already known information, when the information is included in a combination, it is possible to extract distance values R₁, R₂, and R₃ and angles θ₁, θ₂, and θ₃ between each fixed infrastructure.

The present invention uses the extractable elements from the fixed infrastructure combination selected as described above to determine whether the location determination using the fixed infrastructure combinations shows good performance.

As the triangular form connecting the base stations from the meanings of words of the triangulation, the trilateration, and the like, a regular triangle is optimal. In this case, a flat error range of the location determination estimation is reduced. The location determination is generally performed based on the estimated distance between the fixed infrastructures and the nodes to be located. In other words, as illustrated in FIG. 4, an intersection of three circular sets is used by creating a circular set in which a radius is an estimated distance based on the locations of each fixed infrastructure.

For example, as illustrated in FIG. 3, when lengths of three sides and a size of three angles that are six elements of a triangle are the same, an intersection form as illustrated in FIG. 4 becomes the most ideal form. That is, a combination having a form illustrated in FIG. 3 is searched from the fixed infrastructures acceptable in the nodes to be located and is used. To this end, lengths of three sides and a size of three angles among three fixed infrastructures for each of the several combinations of k selected fixed infrastructure may be obtained using N fixed infrastructures acceptable in the node to be located, as illustrated in FIG. 3.

Hereinafter, each combination is aligned to have priority by allocating weighted values to possible fixed infrastructure combinations. When a size of an angle θₙ between the fixed infrastructures illustrated in FIG. 3 is 60°, a regular triangle is formed. Therefore, as an example, the weighted values may be allocated according to Vn=|θₙ−60°|.

For example, if it is assumed that the fixed infrastructures are three, V₁, V₂, and V₃ are generated. A method for determining the weighted values using these values may be various. For example, there are a method using 1-norm when (V₁+V₂+V₃) is small, a method using 2-norm when \sqrt{v₁²+v₂²+v₃²}, and a method using ∞-norm when max(Vn) is small, and the like. Here, the small norm value means that the triangle connecting the fixed infrastructures is slightly deviate from a regular triangle and therefore, it is preferable to search the minimum norm value.

When the comparison of the angles among the fixed infrastructures for each combination as described above is completed, the weighted values for determining priorities for each combination are allocated.

The method for allocating the weighted values may be various. For example, the weighted values of the i-th combination is set to be Wi=K−i/K−1 using numbers 1, 2, . . . , K of each combination aligned in an ascending order by the comparison of the norm value, the first weighted value is set to be 1 and the final K-th weighted value is set to be 0.

The foregoing 1-norm method, 2-norm method, ∞-norm, and the like, are an example of the comparison method and therefore, the scope of the present invention is not limited to the 1-norm method, the 2-norm method, and the ∞-norm method. In addition, the method for allocating the weighted values is not limited to the method such as Wi=K−i/K−1, and therefore, various methods may be applied.

In addition, in addition to the case in which the foregoing three fixed infrastructures are used, even in the case in which at least four fixed infrastructures are used, a regular square, a regular pentagon, and the like, may be applied.

For example, when the regular square is preferred using the four fixed infrastructures, an interior angle of the corresponding regular square is set to be φ, Vn=|θₙ−φ| for the angles θ₁, θ₂, . . . , θₘ among each fixed infrastructure may be used. Further, the following process may use the method for allocating weighted values using the three fixed infrastructures and for convenience of explanation, additional description will be omitted.

As another embodiment of the present invention, even though the angles among the fixed infrastructures are the same, lengths of three sides may be different. When the lengths of three sides are each set to be S₁, S₂, and S₃, it is preferable to select the fixed infrastructures more closed to the nodes to be located for precise location determination. Therefore, like the method applied to the angles, values may be allocated to each combination from the lengths of three sides among the fixed infrastructures of each combination by the 1-norm method, the 2-norm method, the ∞-norm, and the like. As a result, the combinations having the results in which the norm is short due to the length of sides among each combination can be searched and the weighted values may be allocated to the combinations.

As illustrated in FIG. 3, the method for searching preferred combinations to be used for location determination will be described, by way of example, using three angles and three sides among the three fixed infrastructures.

The embodiment of the present invention may further consider the strength of the received signal in addition to the three angles and the lengths of three sides. For example, the norm can be similarly calculated from the strength r₁, r₂, and r₃ of the received signal for the three fixed infrastructures of each combination and the weighted values can be allocated. In this case, the strength ri of the signal may be used as a real value or may be used by being converted into a dB value. When being converted into the dB, the generation of a negative number needs to be considered.

As described above, when each fixed infrastructure combination having three weighted values of a total of three such as the angle, the distance, and the signal strength is calculated, the final weighted value is obtained using the three weighted value to determined the fixed infrastructure combinations to be used for location determination. For example, when the three weighted values for the angle, the distance, and the signal strength are set to be Wᵥ, Wₛ, and Wᵣ, the final weighted value is obtained by adding or multiplying the three values. In this case, the fixed infrastructure combinations having the largest final weighted value is selected, which may be used for location determination.

The determination of the weighted values and the fixed infrastructure combination is previously described by way of example but more general form will be described below.

Hereinafter, for convenience of explanation, the angle, the distance, and the signal strength among several location determination information elements are used and the three fixed infrastructure is assumed to be one combination. That is, it is assumed that three fixed infrastructures for one combination are present and a position thereof is already known.

The three angles V₁, V₂, and V₃, the lengths S₁, S₂, and S₃ of three sides, and the strength r₁, r₂, and r₃ of three received signal are obtained therefrom. Therefore, the final weighted value W is obtained by processing a total of nine variables at one time and the most general Equation form thereof is represented by W=f(v₁, v₂, v₃, s₁, s₂, s₃, r₁, r₂, r₃). For the result, the fixed infrastructure combinations may be immediately selected. However, at the time of processing a total of nine variables at one time as described above, there is a need to control sensitivity of variables of three groups well.

Alternatively, the weighted values for the angle, the length, and the received strength are separately calculated like Wᵥ=fᵥ(v₁,v₂,v₃), Wₛ=fₛ(s₁,s₂,s₃), and Wᵣ=fᵣ(r₁,r₂,r₃) and then, the final weighted value or the select priority can also be calculated by Wₜ=fₜ(Wᵥ,Wₛ,Wᵣ).

Through the above process, the weighted values may be obtained according to the fixed infrastructure combinations to be used for location determination and the select priority may be allocated in an order of the high weighted value and the combination having the highest weighted value may be used or the upper level combinations may be used together. On the other hand, the system may also be constructed so as to avoid the lower level combinations.

As described above, the present invention supplements a disadvantage of the method for selecting the fixed infrastructure in an order of the largest strength of received signal and using the selected fixed infrastructure for location determination in accordance with the related art. In particular, since an RF communication system is a multi-path channel in consideration of characteristics of the wireless channel, the location determination performance is not improved in proportion to the increase in the strength of the received signal due to the NLOS environment and the fading effect. Therefore, it is possible to improve the performance by more efficiently setting the reference of selecting the base station using the location information of the already known fixed infrastructures herein.

The method for more efficiently selecting the fixed infrastructure combinations by allocating the weighted weights using the location determination information elements at the time of selecting the fixed infrastructures to be used for location determination in the wireless location determination is described above.

For reference, a need exists for a message flow for transmitting information between transmission and reception according to which side the calculation is performed during a process of determining the combinations to be used for location determination using the fixed infrastructures acceptable in the nodes to be located as described above.

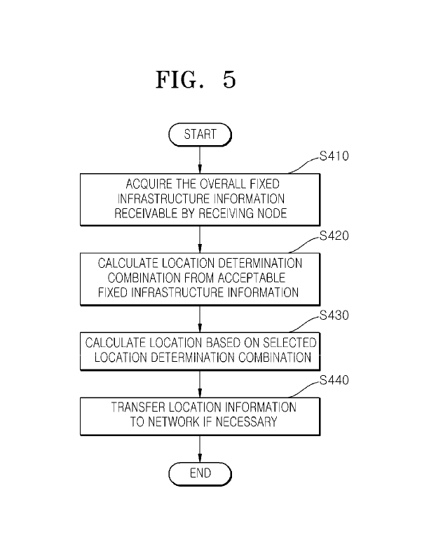

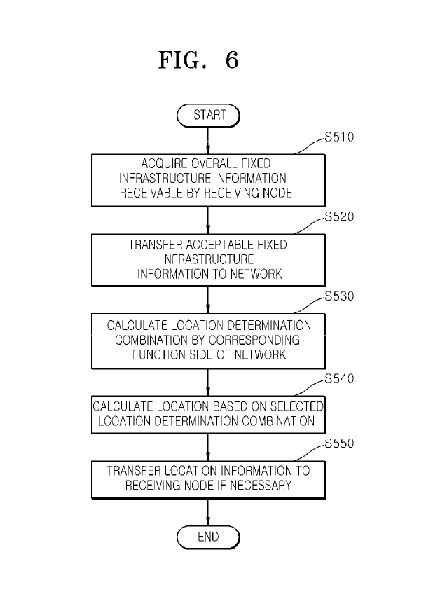

For example, in the case of the downlink location determination, the calculation for selecting the combinations from the received signals may be directly performed by the nodes to be located as illustrated in FIG. 5. That is, FIG. 5 is a flow chart illustrating a process of allowing nodes to be located to calculate a location determination combination in downlink location determination in accordance with an embodiment of the present invention. As illustrated in FIG. 5, receiving nodes (nodes to be located) first acquire (accept) the overall receivable fixed infrastructure information (S410). In addition, the receiving nodes (nodes to be located) calculate and select the location determination combinations from the acceptable fixed infrastructure information (S420). Next, the receiving nodes calculate locations by the selected location determination combinations (S430). In addition, the receiving nodes may also transmit the location information to the network if necessary (S440). On the other hand, in order to more effectively perform the complicated and precise calculation, the calculation is performed in the network as illustrated in FIG. 6. FIG. 6 is a flow chart illustrating a process of allowing a network to perform a calculation of a location determination combination in the downlink location determination in accordance with the embodiment of the present invention. As illustrated in FIG. 6, the nodes to be located first acquire the information of the acceptable fixed infrastructures acquired through the received radio waves (S510). Further, the nodes to be located transmit the fixed infrastructure information to the network (S520). Next, the network calculates and selects the location determination combinations (S530) and calculates the locations based on the selected location determination combinations (S540). In addition, the network may transmit the location information to the receiving nodes (nodes to be located) if necessary (S550).

In accordance with the embodiments of the present invention, it is possible to improve the precision of the wireless location determination by allocating the weighted values for each location determination element for the fixed infrastructures near the nodes to be located in the wireless communication network to select the fixed infrastructure combinations to be used for location determination and performing the wireless location determination using the same.

Further, in accordance with the embodiments of the present invention, it is possible to minimize or suppress the location determination errors or the reduction in location determination performance occurring due to the use of the multi-path channel in consideration of the characteristics of the wireless channel, simplify the system, and prevent the time required for location determination from increasing.

The method and procedure for selecting the fixed infrastructure combinations to be used for wireless location determination by allocating the weighted values to the downlink location determination by the location determination information elements are be described with reference to the embodiments illustrated in the drawings, but this is only the example. Therefore, it will be appreciated by those skilled in the art that various modifications and equivalent other embodiments are possible from the present invention. Therefore, the technical protection scope of the present invention should be defined by the appended claims.

What is claimed is:

1. A wireless location determination apparatus using weighted values in a wireless communication network, comprising:
a fixed infrastructure searching unit configured to search and accept information of fixed infrastructures adjacent to nodes to be located;
an infrastructure combination generating unit configured to generate fixed infrastructure combinations to be used for location determination from the information of the fixed infrastructures;
a location determination information element extracting unit configured to extract location determination information elements between the fixed infrastructures from each generated fixed infrastructure combination;
a weighted value calculating unit configured to allocate the weighted values to each fixed infrastructure combination using the extracted location determination information elements;
a fixed infrastructure combination selecting unit configured to select the fixed infrastructure combinations for location determination using the allocated weighted values; and
a location calculating unit configured to calculate locations of the nodes to be located using the selected fixed infrastructure combinations.

2. The wireless location determination apparatus of claim 1, wherein the location determination information element includes at least any one of angle and distance between the fixed infrastructures and strength of received signals from the fixed infrastructures.

3. The wireless location determination apparatus of claim 1, wherein the weighted value calculating unit calculates final weighted values of the infrastructure combinations by applying all the location determination information elements to one function equation or
calculates the final weighed values of the infrastructure combinations by separately calculating the weighed values for each type of the location determination information elements and then, adding or multiplying the calculated weighted values.

4. The wireless location determination apparatus of claim 1, wherein the fixed infrastructure combination selecting unit selects the infrastructure combinations in an order of the large weighted value.

5. The wireless location determination apparatus of claim 1, wherein the fixed infrastructure combination selecting unit selects the infrastructure combinations by avoiding the infrastructure combinations in an order of the small weighted value.

6. A wireless location determination method using weighted values in a wireless communication network, comprising:
accepting information of fixed infrastructures adjacent to nodes to be located;
generating fixed infrastructure combinations to be used for location determination from the information of the fixed infrastructures;
extracting location determination information elements between the fixed infrastructures from each generated fixed infrastructure combination;
allocating the weighted values to each fixed infrastructure combination using the extracted location determination information elements;
selecting the fixed infrastructure combinations for location determination using the allocated weighted values; and
performing location calculation using the selected fixed infrastructure combinations.

7. The wireless location determination method of claim 6, wherein the information of the fixed infrastructures is processed by being accepted in the nodes to be located.

8. The wireless location determination method of claim 6, wherein the fixed infrastructure combinations are generated by the nodes to be located.

9. The wireless location determination method of claim 8, wherein the nodes to be located select the fixed infrastructure combinations for location determination and the locations are calculated using the selected fixed infrastructure combinations.

10. The wireless location determination method of claim 6, wherein the fixed infrastructure information is transferred to a transmitting side from the nodes to be located and the transmitting side generates the fixed infrastructure combinations.

11. The wireless location determination method of claim 10, wherein the transmitting side selects the fixed infrastructure combinations for location determination and calculates the locations using the selected fixed infrastructure combinations.

12. The wireless location determination method of claim 6, wherein the weighted value allocated to each fixed infrastructure is calculated by applying all the location determination information elements to a single function equation or
is calculated by a method of obtaining the final weighed values of the infrastructure combinations by separately calculating the weighed values for each type of the location determination information elements and then, adding or multiplying the calculated weighted values.

13. The wireless location determination method of claim 6, wherein the selecting of the fixed infrastructure combination for location determination is performed by a method of selecting the infrastructure combinations in an order of the large weighted value.

14. The wireless location determination method of claim 6, wherein the selecting of the fixed infrastructure combination for location determination is performed by a method of selecting the infrastructure combinations by avoiding the infrastructure combinations in an order of the small weighted value.
